(19) United States
(12) Patent Application Publication
(10) Pub. No.: US 2002/0087423 A1
(43) Pub. Date: Jul. 4, 2002

(54) System builder for building electronics systems

(76) Inventors: Joan L. Carbrey Palango, Garden Grove, CA (US); Tsuyoshi Koda, Torrance, CA (US); Todd Van Zandt, San Dimas, CA (US); Yoshihiko Hashiba, Iwaki-city (JP); Motoyoshi Niitsuma, Iwaki-city (JP)

Correspondence Address: MURAMATSU & ASSOCIATES, Suite 225, 7700 Irvine Center Drive, Irvine, CA, 92618, US

(21) Appl. No.: 09/752,476

(22) Filed: Jan. 2, 2001

(51) Int. Cl. G06F 17/60

(52) U.S. Cl. 705/26

(57) ABSTRACT

A system builder is operable on a customer terminal for creating a configuration of an electronics system through a communication network. The system builder includes a main system selection page for listing a plurality of main systems wherein a customer selects one of the main systems that matches the customer's requirements, a sub-system selection page for displaying a plurality of sub-systems within the main system wherein the customer selects one of the sub-systems that matches the customer's requirements, and a component selection page for displaying a list of recommended components appropriate for configuring the selected sub-system wherein the customer selects components configuring the sub-system that match the customer's requirements.

### FIELD OF THE INVENTION

This invention relates to a system builder and method for enabling the selection and configuration of electronics system through communication networks. More specifically, this invention relates to a system builder enabling the selection, configuration and cost estimation of automobile audio, video, and/or navigation systems so as to enable remote system build-up and cost estimation of valid and acceptable configurations of those products.

### BACKGROUND OF THE INVENTION

A customer wishing to buy a complex product such as an automobile entertainment system is faced with a large number of interdependent choices and limited connectivity. Because of the variety of customer's specific needs for automobile audio, video and/or navigation systems (automobile entertainment systems) as well as the complexity of automobile sizes, types and makes for installing such systems, manufacturers of such automobile entertainment systems provide a large number of different components for building variety of systems.

Such components include AM/FM head units, compact disc changes, head units, mini-disc head units, speakers and sub-woofers with various sizes and output powers, amplifiers, DVD units, monitors, navigation systems, and the like. Recent components used in such systems are highly sophisticated and complicated which frequently include microcomputers. Thus, it is difficult for customers to determine which components meet their needs and what combinations of such components match their needs. Moreover, in reality, there are limited connectivity and complex connection requirements among such system components even when such products are provided by the same manufacture.

The present invention is not limited to the application of transaction of such automobile entertainment products, but can be advantageously applicable to any complicated systems and products. However, for the simplicity and convenience of explanation, the present invention is described with respect to the application of automobile entertainment products.

In the automobile entertainment systems (e.g., audio, video and/or navigation) market at present, a typical sale takes place as follows: A customer visits an automobile dealer or a shop handling such automobile products and meets a salesperson with catalogs and samples. The customer selects various options based on the information obtained in the dealer. Generally, the customer does not have any prior knowledge about automobile entertainment systems or components configuring such systems. The customer has to learn how each system or component works differently from others to find a system that meets his needs. The customer may not have any knowledge about the price of the system of components. Thus, the customer may have to visit the dealer several times. This whole order process takes a very long time, which burdensome to both the customer and the dealer.

Alternatively, the customer may be able to acquire prior knowledge through a communication network such as the Internet by accessing a home page of the supplier of such automobile audio and video products. At present, examples of site that provide various audio and video components merely categorize and list the components. There appears no Web sites that can advice a customer as to a particular system that meets the customer's wants and possible combination of components forming such a system. There appears no Web sites that can evaluate the validity of the system and components with respect the particular automobile of the customer.

The selection process available today is inefficient, inaccurate, and inconvenient. Therefore, there is a need in the industry for an intelligent, accurate and efficient system builder for selection of complex products such as automobile entertainment systems.

### SUMMARY OF THE INVENTION

It is an object of this invention to provide a system builder which is an intelligent tool that provides customers with production information of a supplier while guiding the customer through the evaluation of their needs and product selection and system configuration process.

It is another object of the present invention to provide a system builder and method that assists a customer in building a complex electronics system such as an automobile entertainment system and selecting components for such a system while confirming price information of such an entertainment system.

It is a further object of the present invention to provide a system builder and method that is easy to use, accurate, and provides the customer with a way to determine whether or not the customer has a valid, available system configuration which meets the current condition of the customer's vehicle.

It is a further object of the present invention to provide a system builder and method which has a graphical user interface that generates visual images of the audio/video and navigation systems, thereby guiding a customer to decide an automobile entertainment system that meets the customers specific needs.

It is a further object of the present invention to provide a system builder which is capable of sending the information regarding the audio/video and navigation systems through a communication network while recommending systems and components based on variety of factors.

Accordingly, in one aspect, this invention provides a system builder having a graphical user interface to a computer program through a communication network for configuring an audio/video and navigation system provided by a supplier (manufacturer) that meets the customer's unique preference. The system builder presents a customer with various selectable options via display screens of a customer terminal. Depending upon which options the customer selects, the system builder provides the customer with information about the product selected or receives input from the customer about his requirements.

The customer can interact with the system builder to select a basic configuration of a main system, select a sub-system in within the selected main system, select components configuring the selected sub-system. At all times, the customer is able to ensure that the current system configuration is valid (available by the manufacture, fit to his automobile, and compatible with other components) and the user is able to obtain price information about each component and overall system configuration.

The customer, via the system builder, can modify a configuration by adding or deleting components in the configuration or by changing his automobile. When the components in the selected system is adjusted, the system builder generates a valid combination of the components within the selected system. Such a valid combination is made in view of the other components such as compatibility therebetween, the type and requirements of his automobile such as dashboard sizes and other opening sizes.

### BRIEF DESCRIPTION OF THE DRAWINGS

FIG. 1 is a schematic block diagram showing an overall configuration of the system builder of the present invention including the communication network.

FIG. 2 is a flow diagram showing a basic operation flow of the system builder of the present invention.

FIG. 3 is an illustration showing an example of system selection page shown on the customer display monitor according to the system builder of the present invention.

FIG. 4 is an illustration showing an example of sub-system selection page according to the system builder of the present invention.

FIG. 5 is an illustration showing another example of sub-system selection page according to the system builder of the present invention.

FIG. 6 is an illustration showing an example of sub-system selection page wherein images of all of the sub-systems are illustrated in one page according to the modified version of the system builder of the present invention.

FIG. 7 is an illustration showing an example of vehicle search page according to the system builder of the present invention.

FIG. 8 is an illustration showing an example of component selection and price estimation page according to the system builder of the present invention.

FIG. 9 is an illustration showing an example of check out page for confirming the selected system and components according to the system builder of the present invention.

FIG. 10 is a schematic diagram showing an example of hierarchical relationship among the systems, sub-systems and components according to the system builder of the present invention.

### DETAILED DESCRIPTION OF THE PREFERRED EMBODIMENTS

The invention provides a system builder which is an intelligent tool for building an automobile entertainment system such as an audio, video and/or navigation system provided by a supplier (manufacturer, or seller). The system builder of the present invention is not limited to the application of automobile entertainment systems, but can be applicable to any other systems and products. Thus, the following description of the present invention with respect to automobile entertainment products is made only for the illustration purpose.

The system builder of the present invention assists a customer (buyer) in assessing his unique needs, selecting the specific system based on the needs assessment through a system selection process and a sub-system selection process, determining components for the selected sub-system, adding further components if the customer wants, confirming the price and printing out his final system configuration. Based on the information obtained through the system builder, the customer may visit a dealer to purchase the components and have his system install in his automobile.

During this process, the system builder recommends a system configuration that best matches the customer's needs, based upon the results of an interactive customer product selection session. The customer progresses through a hierarchical selection process from a generic level (main system selection), an intermediate level (sub-system selection), to a specific level (component selection). The system builder has an intelligent graphical user interface through which the customer can monitor the information including images of systems and build his system with lessor key operations and a shorter time.

The customer is able to ensure that the current system configuration is valid as to the compatibility among the components, fitment to his particular automobile type, or the like. The customer, via the graphic user interface of the system builder, can modify a configuration of the system by adding or deleting components in the system or by changing his automobile. When modifying the components for his selected system, the system builder regulates so that such a change can only be effective in a valid combination in view of the other components and requirements of his automobile, thereby maintaining the right selection.

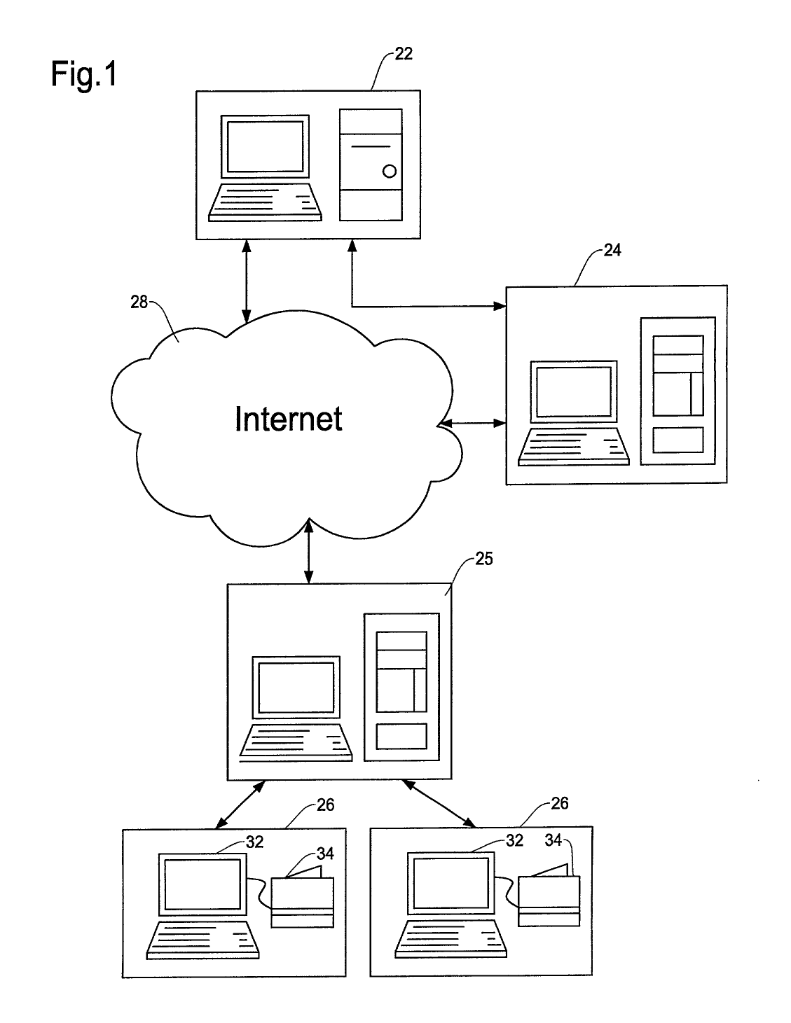

An overall configuration of the system builder of the present invention including the communication network is shown in the schematic diagram of FIG. 1. The system builder operates in connection with a customer terminal 26 when the customer accesses a manufacture (supplier) server 22 through a communication network 28. For example, the communication network 28 is supported by technologies such as Internet and world wide web (WWW). The customer terminal 26 may include a workstation or a personal computer 32 and a printer 34. The manufacturer server 22 may be a workstation or a personal computer. Numerals 24 and 25 denote Internet provider servers. The manufacturer server 22 may be directly connected to the Internet 28 or through the provider server 24. The customer servers 26 may be connected to the Internet 28 through the provider server 25.

Typically, the customer connects his computer 32 using any known connection technology including, for example, LAN, dial-up, or wireless connection technology and accesses a Web page of the manufacture. The manufacture server 24 provides various links in the home page including the system builder of the present invention. Thus, by clicking the link indicating the system builder, the customer terminal 26 receives a program and data from the manufacture server 22 through the communication network 28, which starts the operation of the system builder.

The system builder is preferably implemented in a computer program, for example dynamic HTML or JAVA script, although it may be implemented in other programming languages as well. The customer terminal 26 includes the computer 32 and an input device which may be a pointing device, such as a mouse or trackball, and/or a keyboard, a display monitor, and a browser such as Netscape Communicator. The browser provides a graphical user interface that presents a familiar look and feel to most field personnel and customers and thus provides a user with a readily accepted environment in which to operate the system builder.

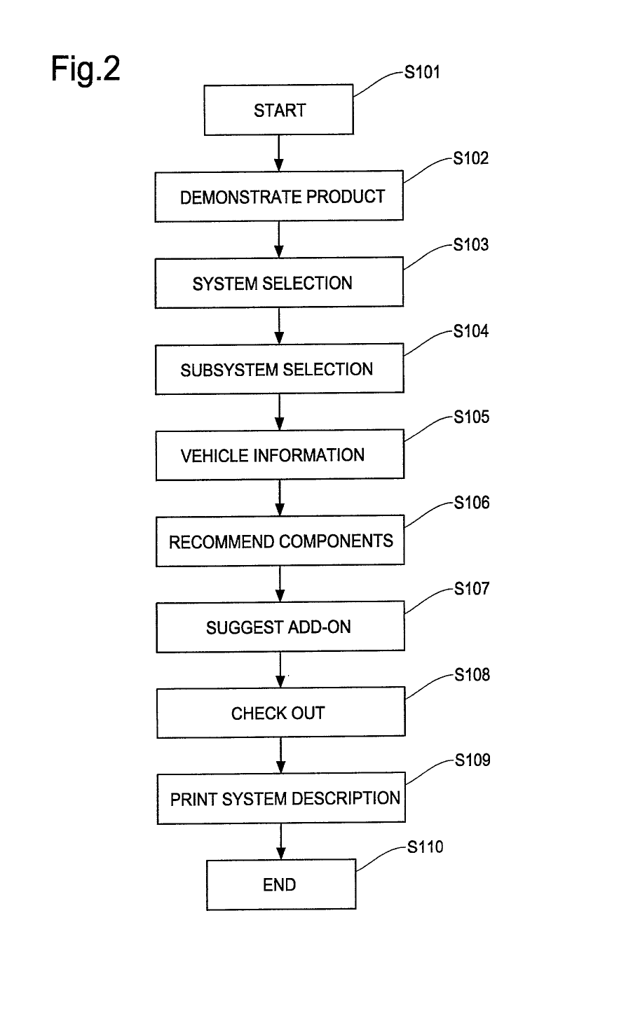

The basic operation of the system builder of the present invention on the customer terminal 26 is shown in a flow diagram of FIG. 2. It should be noted that, although the operational flow is illustrated in only one direction, customers may go back and forth in this flow diagram in an actual operation of this system.

The operation starts at step S101 by clicking the start button. After introductory pages, in step S102, the customer terminal 26 demonstrates examples of products available by the manufacturer. The products in this example are automobile entertainment systems such as audio, video and navigation systems. The system builder provides an interactive, on-line product selection dialog which starts at step S103. The selection dialog in the system builder is configured by three layers of selection step, i.e, a (main) system selection step, a sub-system selection step, and a component selection step.

For example, the system builder provides seven main systems which are illustrated by images on the monitor display of the customer terminal. Based on his specific needs, the customer selects one of the system at step S103 by clicking one of the images. Then, the process moves to a step S104 for selecting a sub-system of the automobile entertainment system. For example, the system builder provides several sub-systems for each system. Throughout the system selection and sub-system selection steps, the system builder explains features, effects and recommendations regarding the systems while showing variety of needs and wants that customer may have. Based on such information on the display, the customer selects the system and sub-system he likes in the foregoing steps.

After selecting the sub-system, the system builder moves to step S105 wherein the customer inputs vehicle information such as make, model and year. The system builder needs this process to know which components fit to the customer's particular vehicle and which components do not fit to the customer's vehicle. For example, because sizes of openings or frames of the front panel for instruments or attachment openings and depths for speakers may vary from vehicle to vehicle, certain components may not be available for his vehicle or need special kits for installation.

In step S106, the system builder shows a list of recommended components, i.e., proposal, for the selected sub-system. The recommended components are automatically determined based on the sub-system selected by the customer and the vehicle information provided by the customer. Each component is shown by its model, a number of unit, features, price and the like. Further, the system builder provides HTML links to the detailed information of each component so that further details of the component information including a specification and a picture of the component can be extracted from the manufacturer's data base.

Because the system builder generates the recommended components with use of the vehicle fitment information, the customer can always build a correct combination of the products for his automobile. By check-marking the components on the display screen, the customer selects the components he likes. In the preferred embodiment of the present invention, the system builder may also suggest additional components at step S107. Such add-on components may further enhance the effects of the selected system. If he wants, by check-marking the components on the display screen, the customer selects the add-on components.

The recommended components or suggested add-on components can be changed by the customer. In the case where such changes require changes in the other components, the system builder automatically generates a right combination of the products. The system builder shows each price of the component and total price of the system throughout the component selection steps of S106 and S107. The system builder then moves to step S108 for checking out which shows a final system configuration and price. The customer may print out the check out page at step S109 before visiting a dealer for purchase and installation. The operation of the system builder ends at step S110.

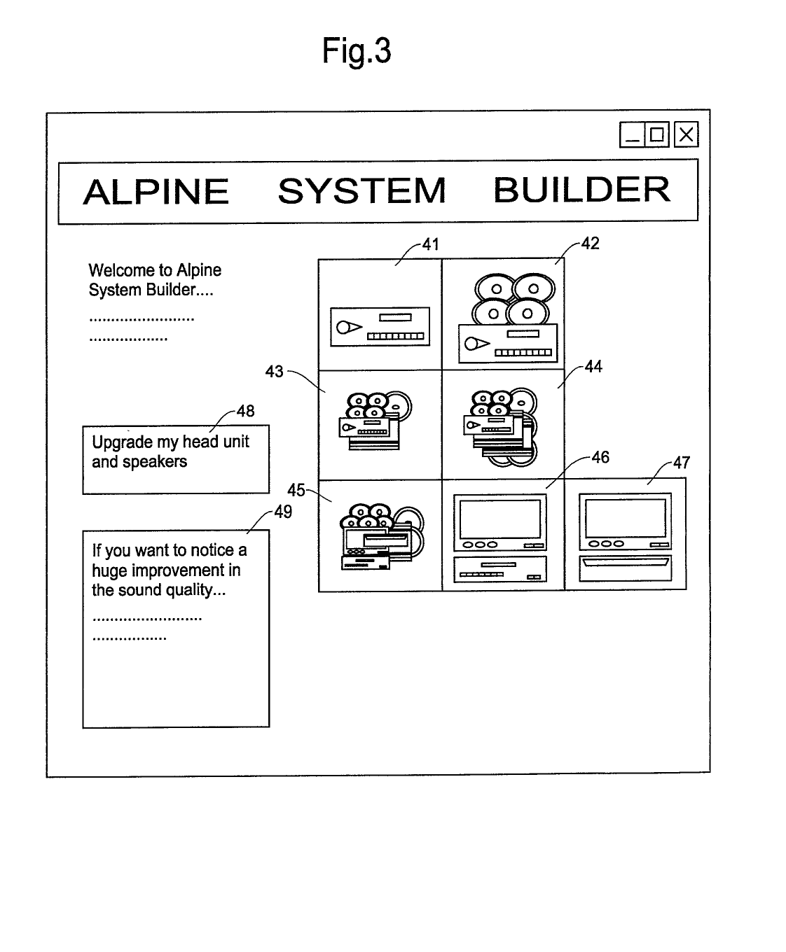

FIG. 3 shows an example of illustration in the system selection page according to the system builder of the present invention. In this example, the display monitor of the customer terminal 26 shows images 41-47 of seven main systems. When pointing one of the systems, by a pointing device such as a mouse, a description box 48 shows the type of system specified by the customer and a description box 49 shows a detailed description of the purpose, feature, effect, and further recommendation with respect to the system described in the box 48. Thus, by pointing one of the images on this page, the descriptions in the boxes 48 and 49 automatically change. In the example of FIG. 3, the descriptions in the description boxes 48 and 49 are derived when pointing the image 42.

The system builder describes the type of main system by languages which assess the customer's specific wants. For example, the system of image 41 is described as “I want to upgrade my head unit”, the system of image 42 is described as “I want to upgrade my head unit and speakers”, the system of image 43 is described as “I want to upgrade my system with a head unit and speakers and amplifiers”, and the system of image 44 is described as “I want a system that can really “Play Load””. Similarly, the system of image 45 is described as “I want my car to be a digital theater on wheels”, the system of image 46 is described as “I want a piece and quiet, in other words, a “Rear Seat Entertainment””, and the system of image 47 is described as “I want an accurate, easy-to-use Navigation System”.

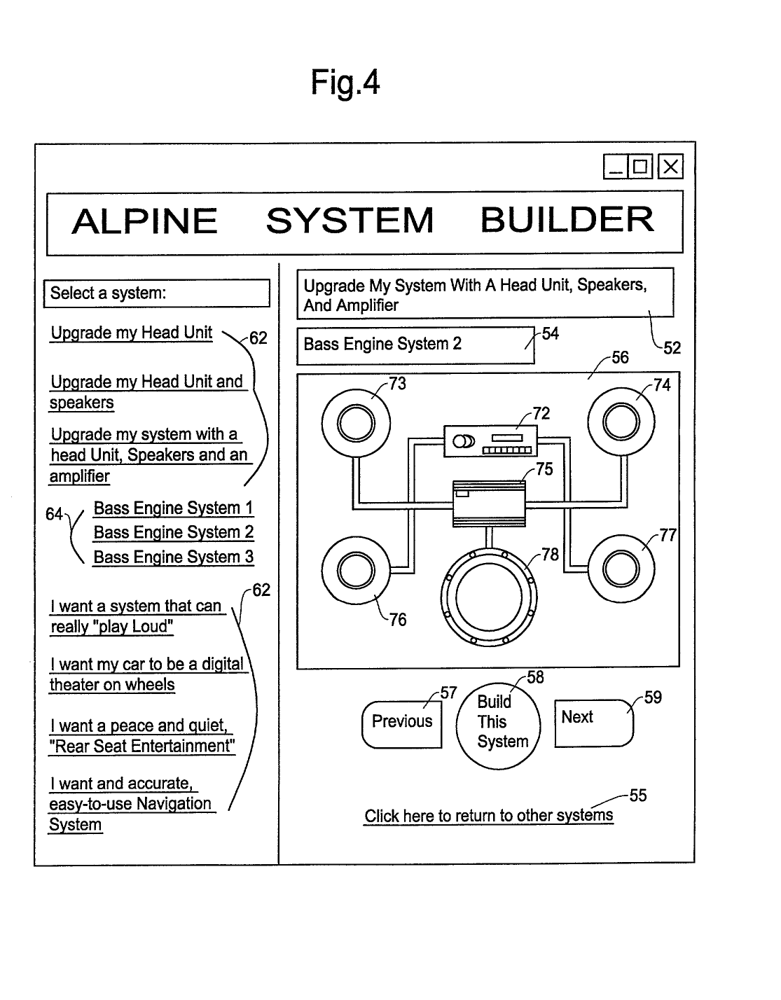

Based on the images and descriptions in the system selection page of FIG. 3, the customer can select a (main) system that fits his needs and clicks the image of the selected system, which brings the customer to a sub-system selection page of FIG. 4. This example shows the case where the main system of the image 43 “I want to upgrade my system with a head unit and speakers and amplifiers” in FIG. 3 is selected and a sub-system “Bass Engine System 2” is selected in the sub-system selection page. In the left column, the sub-system selection page shows links 62 of the seven main systems and a list 64 of sub-systems in the selected main system. By clicking the other main system, a list of sub-systems appears while the previous list of sub-system is closed.

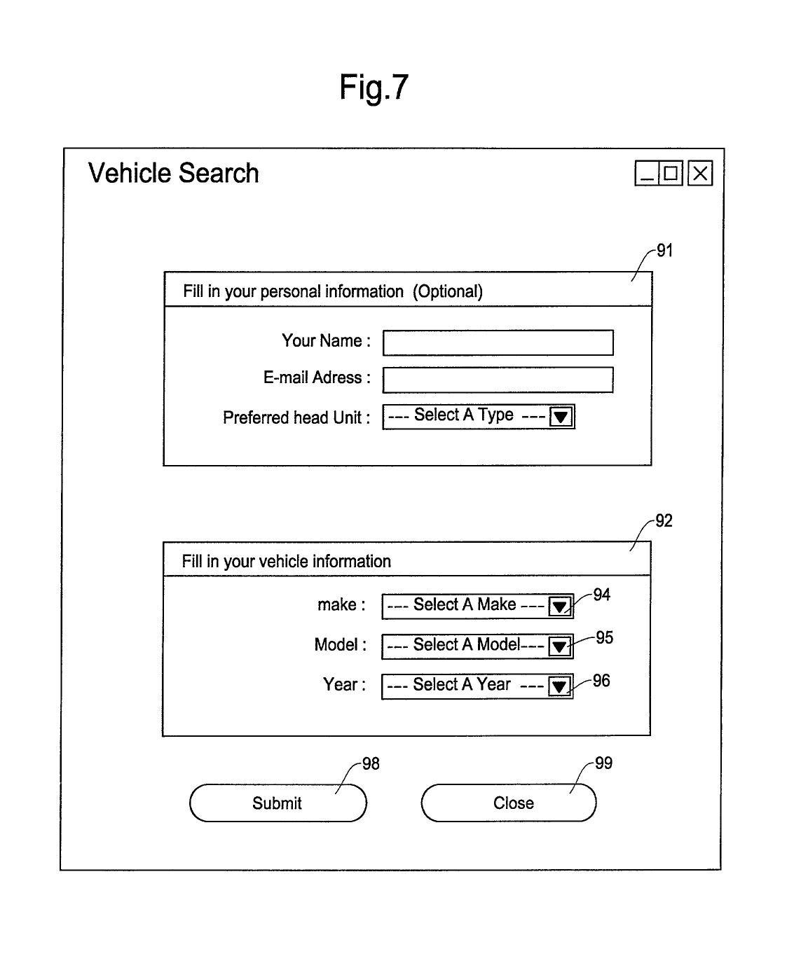

In the right column of the page, a box 52 indicates the system type described above, and a box 54 indicates the type of sub-system “Bass Engine System 2” noted above. The image of the sub-system is shown in an image box 56. In this example, the image of the selected sub-system includes a head unit 72, rear speakers 73 and 74, an amplifier 751 front speakers 76 and 77 and a subwoofer 78. The sub-system selection page of FIG. 4 further shows a “Previous” button 57 for going back to the previous screen, a “Next” button 59 for going to the next screen, and a “Build This System” button 58 for selecting components of the system shown in this page. By clicking the button 58, the system builder moves to a vehicle information page of FIG. 7 which will be described later. The customer can select other sub-systems by clicking the links in the sub-system list 64.

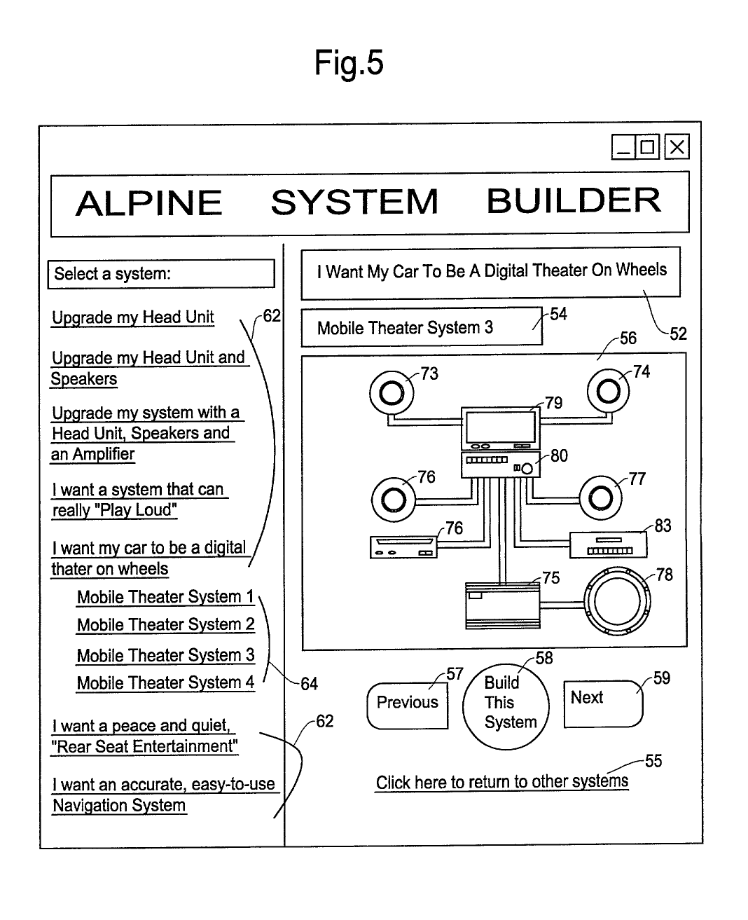

FIG. 5 shows another example of the sub-system selection page in the system builder of the present invention. This example shows the case where the main system of indicated by the image 45 “I want my car to be a digital theater on wheels” in FIG. 3 is selected and a sub-system “Mobile Theater System 3” is selected in the sub-system selection page. The type of the main system is shown in the box 52, the type of the sub-system is shown in the box 54, and the image of the selected sub-system is shown in the image box 56.

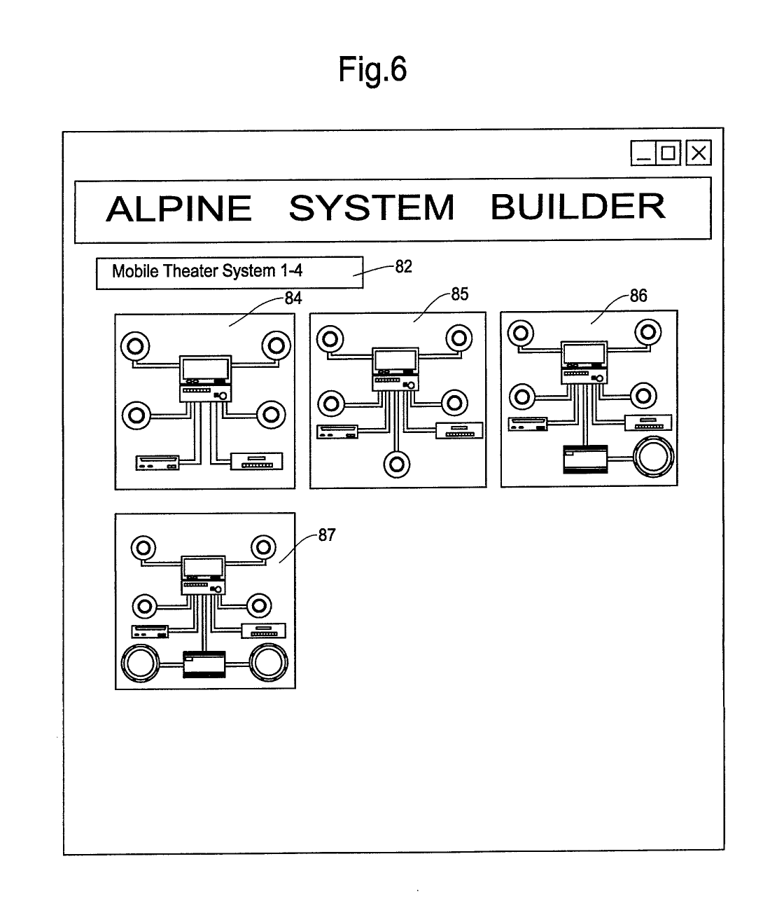

FIG. 6 shows a modified version of the system builder in which all of images of the sub-systems of the selected main system are illustrated in one page. This page may be advantageously provided between the main system selection page of FIG. 3 and the sub-system selection page of FIG. 4 or 5. Thus, in this example, by clicking one of the images 41-47 in FIG. 3, the system builder moves to the page of FIG. 6 to show all of the images of the sub-systems in the selected main system. Then, by clicking one of the images of the sub-systems, the system builder displays the sub-system selection page of FIG. 4 or 5. When the customer wants to go back to FIG. 6 to see other systems, he clicks a link 55 at the bottom indicating “click here to return to other systems”. The example of FIG. 6 is especially useful when the number of sub-system is large because the customer can see all of the images of the sub-systems at once.

By clicking the “Build This System” button 58 in FIG. 4 or 5, the system builder moves to the vehicle information page of FIG. 7 where the customer provides the information regarding his automobile. As noted above with reference to the flow diagram of FIG. 2, the system builder needs to know about the customer's vehicle to determine which components fit and which component do not fit to the customer's vehicle. Each automobile has different sizes in its dashboard, such as 1 DIN or 1.5 DIN frame (DIN: German Industrial Standard), or speaker openings and depths in the front and rear. Such inner sizes may vary depending on make, model and year of the vehicle. Therefore, some components may not be available for his vehicle or need special kits or adapters for installation.

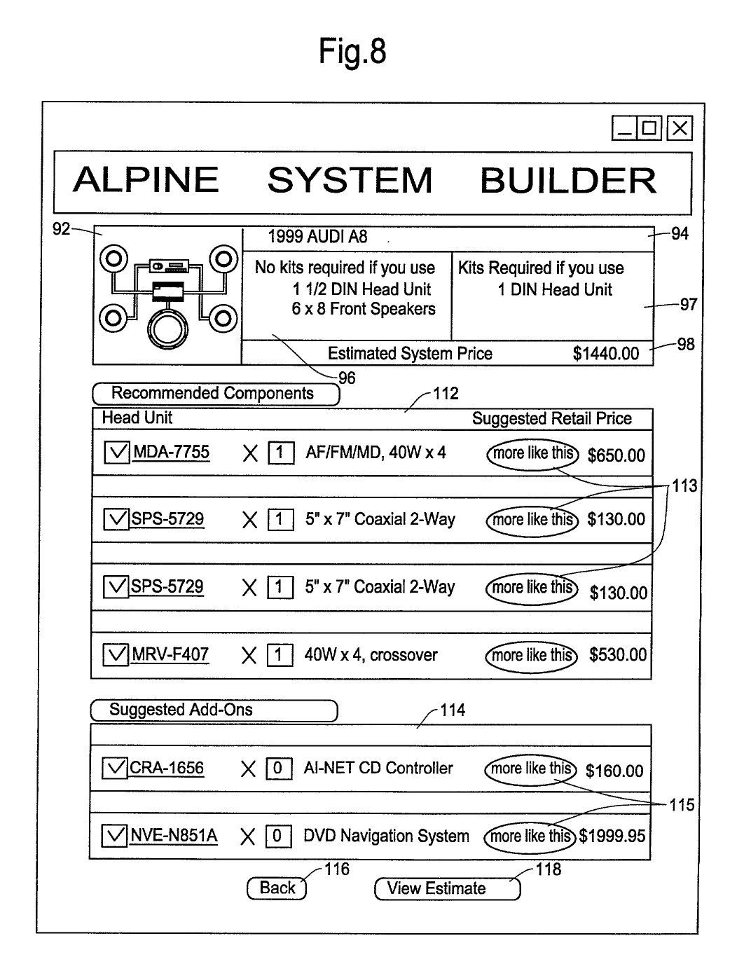

Thus, in the vehicle information page of FIG. 7, the customer supplies his vehicle information in a box 92 as to the make (box 94), model (box 95) and year (box 96). The customer may optionally provides his personal information in a box 91 as to his name, e-mail address and the like. The vehicle information page also shows a “Submit” button 98 and a “Close” button 99. If the customer wants to go back to the previous pages, he clicks the “Close” button 99. After providing the necessary vehicle information in the box 92, the customer clicks the “Submit” button 98, which brings the system builder to the components selection page of FIG. 8.

In the component selection and price estimation page of FIG. 8, the system builder shows a list of recommended components in a box 112 and suggested add-ons in a box 114. The boxes 112 and 114 include “more like this” buttons 113 and 115 to search other components with similar functions. The image of the configuration of the selected system is shown in an image box 92. Based on the vehicle information given by the customer, the system builder shows the year, make and model of the customer's vehicle in a box 94. Further based on the vehicle information, the system builder tells the customer about the vehicle fitment information such as appropriates sizes of the head units (e.g., 1 DIN head unit, 1.5 DIN head unit), sizes of speakers and the like. Such fitment information is also used in forming the list of the recommended components in the box 112 and the suggested add-ons in the box 114. An estimated total system price is shown in a box 98.

The recommended components are automatically determined based on the sub-system selected by the customer and the vehicle information provided by the customer. The manufacturer may have a variety of similar components such as head units that are feasible to the selected system. Suppose there are many components such as head units of different models which are applicable to the selected system, the system builder places priority in listing the components based on various factors. For example, the system builder may list, as a higher priority, a head unit which is most popular in the market, i.e., a “hit” model, or a head unit which is a newer model, or a head unit having a higher profit margin, or the like. Other factors may include reliability, amount of stocks, season, competitors product line-ups, prices and so on.

In the box 112, each component is shown by its model, a number of unit, features, price and the like. Further, the system builder provides HTML links to the detailed information of each component so that further detailed information including a specification and a picture of the component can be extracted from the manufacturer's data base. Because the system builder generates the recommended components with use of the vehicle fitment information, the customer can always build a correct combination of the components that matches his automobile.

If the customer likes the recommended component in the box 112 in FIG. 8, he selects the component by check-marking the component. If he wants to see other recommended components, he clicks the “more like this” button 113. As noted above, in the preferred embodiment of the present invention, the system builder shows the suggested add-ons in the box 114. Such add-on components may further enhance the effects of the system selected by the customer. If he likes the add-ons, the customer selects the component by check-marking the component. If he wants to see other add-ons, he clicks the “more like this” button 115.

When the recommended components or the suggested add-on components are changed by the customer, the system builder automatically generates a right combination of the products by changing the other components. This is done basically by the vehicle fitment information because the selected component by the customer may not fit to the inner structure of the customer's automobile. Other reason is that the selected component may not be compatible with other components. If the customer's change results in the combination which is incurable, the system builder so notifies the customer.

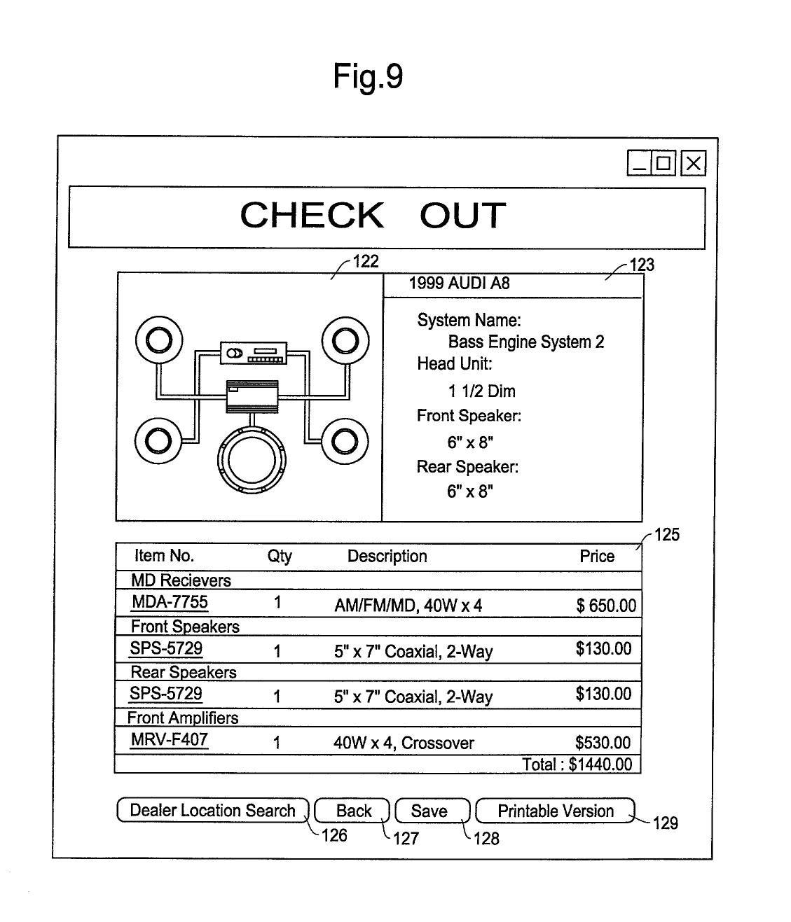

The system builder shows each price of the component in the boxes 112 and 114 and the total price of the system in the box 98 throughout the component selection process. Thus, the customer can build his system based on the performance and appearance of the system as well as the price of the system. If the customer wants to go back to the previous pages, he clicks a “Back” button 116. If the customer wants to further proceed, he clicks a “View Estimate” button 118, which brings the system builder to the check out page of FIG. 9.

The check out page of FIG. 9 shows the final system configuration and the resultant price. An image of the selected system is illustrated in an image box 122 and the vehicle information including the sizes of the dashboard frames and speaker openings is shown in a box 123. A component box 125 shows a list of selected components with the name, price and brief description of function of each component. The example of FIG. 9 further includes a “Dealer Location Search” button 126 for searching dealers that handle the selected system and components and can install the system in the customer's vehicle, a “Back” button to go back to previous pages, a “Save; button 128 to save the information, and a “Printable Version” button 129 for printing the information.

Based on the information thus obtained through the system builder of the present invention, the customer may visit the dealer to purchase and install the automobile entertainment system in his car.

As in the foregoing, the process of building the automobile entertainment system is a hierarchical process, from general to specific. The generalized statements and images describing the main systems are given in the first layer. Then more specific statements and images describing the sub-systems within the selected main system are shown in the second layer. Finally, the recommended components are shown on the display to select specific components that forming the selected system. The customer can change the selection at all times by going back and forth between the different layers.

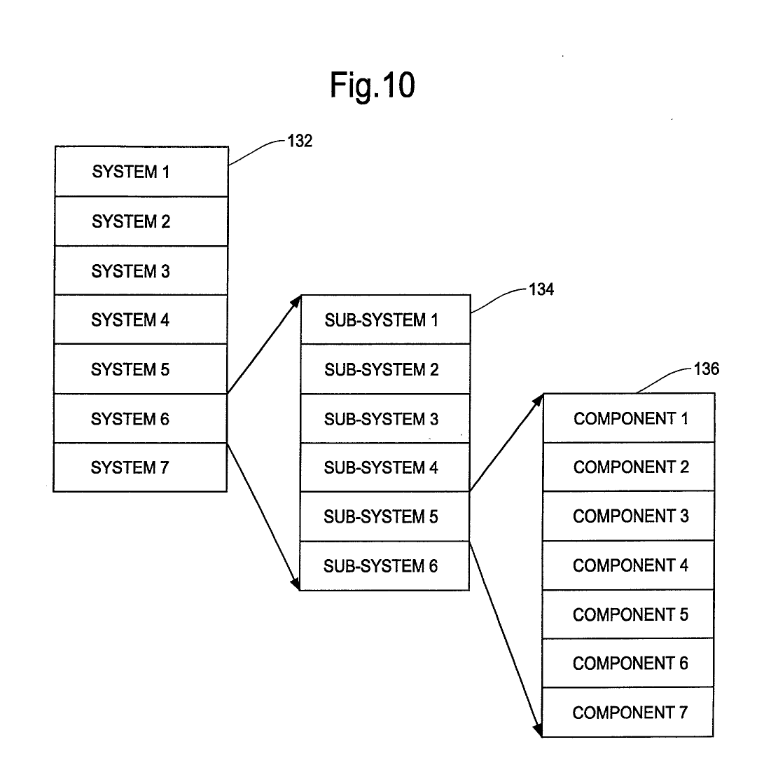

Such a hierarchical structure is shown in FIG. 10. A system group 132 includes two or more main systems, and a sub-system group 134 includes two or more sub-systems for each main system in the system group 132. Thus, there are two or more sub-system groups 134 each having the sub-systems for the corresponding main system. In other words, a large number of sub-system groups are stored in the system builder. A component group 136 includes components that can configure the corresponding sub-system in the sub-system group 134. Thus, a large number of component groups are stored in the system builder. The combinations of such components in the component group will be changed dynamically and automatically by the system builder with the change in the selection by the customer and automatic adjustment based on the fitment described in the foregoing.

As has been described in the foregoing, according to the present invention, the system builder provides the customer with the product information while guiding the customer through the evaluation of his needs and product selection and system configuration process. The system builder assists the customer in building the automobile entertainment system and selecting components for such a system while confirming the price information of such an entertainment system. The system builder of the present invention is easy to use and accurate in building a valid system configuration which meets the current condition of his vehicle.

Although the invention is described herein with reference to the preferred embodiment, one skilled in the art will readily appreciate that other applications may be substituted for those set forth herein without departing from the spirit and scope of the present invention.

What is claimed is:

1. A system builder operable on a customer terminal when accessing a supplier terminal through a communication network for creating a configuration of an electronics system using components provided by a supplier, comprising:
a main system selection page for listing a plurality of main systems each being expressed by an image of the main system and statements describing the main system, wherein a customer selects one of the main systems that matches the customer's requirements;
a sub-system selection page for displaying a plurality of sub-systems within the main system each being expressed by an image of the sub-system and associated statements where the image shows relationships among components in the sub-system, wherein the customer selects one of the sub-systems that matches the customer's requirements; and
a component selection page for displaying a list of recommended components appropriate for configuring the selected sub-system in which each component being accompanied by price information, model name and description of function, wherein the customer selects components configuring the sub-system that match the customer's requirements.

2. A system builder as defined in claim 1 wherein the customer terminal accesses the supplier terminal through the communication network which is Internet to activate the system builder by interaction between the customer terminal and the supplier terminal.

3. A system builder as defined in claim 1 wherein the component in the sub-system recommended by the system builder can be changed by the customer when a replaceable component is found in the component selection page, wherein the system builder examines validity of a combination of the components when the change in the component is made and changes other component in the sub-system to create a right combination if the combination caused by the customer is invalid.

4. A system builder as defined in claim 1, wherein configuration of the electronics system is determined through a hierarchical order from the main system selection page which provides a selection step for broad systems, the sub-system selection page which provides a selection step for more specific systems, to the component selection page which provides a selection step to determine specific components in the system.

5. A system builder operable on a customer terminal when accessing a supplier terminal through a communication network for creating a configuration of an automobile entertainment system using components provided by a supplier, comprising:
a main system selection page for listing a plurality of main systems each being expressed by an image of the main system and statements describing the main system, wherein a customer selects one of the main systems that matches the customer's requirements;
a sub-system selection page for displaying a plurality of sub-systems within the main system each being expressed by an image of the sub-system and associated statements where the image shows relationships among components in the sub-system, wherein the customer selects one of the sub-systems that matches the customer's requirements;
a vehicle information page for supplying information regarding customer's vehicle by the customer for determining fitment of the components in the sub-system with respect to physical conditions of the customer's vehicle;
a component selection page for displaying a list of recommended components appropriate for configuring the selected sub-system in which each component being accompanied by price information, model name and description of function, wherein the customer selects components configuring the sub-system that match the customer's requirements.

6. A system builder as defined in claim 5 wherein the customer terminal accesses the supplier terminal through the communication network which is Internet to activate the system builder by interaction between the customer terminal and the supplier terminal.

7. A system builder as defined in claim 5 wherein the component in the sub-system recommended by the system builder can be changed by the customer when a replaceable component is found in the component selection page, wherein the system builder examines validity of a combination of the components based on the vehicle information when the change in the component is made and changes other component in the sub-system to create a right combination if the combination caused by the customer is invalid with respect to the customer's vehicle or compatibility with other components.

8. A system builder as defined in claim 5 further comprising an overall sub-system page which shows images of all of sub-systems available in the selected main system wherein the sub-system selection page is displayed on the customer terminal when specifying one of the images in the overall sub-system page.

9. A system builder as defined in claim 5 further comprising a check out page for confirming final selection of the sub-system and the selected components that compose the selected sub-system.

10. A system builder as defined in claim 5, wherein configuration of the automobile entertainment system is determined through a hierarchical order from the main system selection page which provides a selection step for broad systems, the sub-system selection page which provides a selection step for more specific systems, to the component selection page which provides a selection step to determine specific components in the system.

11. A system builder as defined in claim 5 wherein the component selection page shows a price of each component listed and a total price of the sub-system configured by the selected components.

12. A system builder as defined in claim 5 wherein the vehicle information of the customer's vehicle is used for determining a dashboard size for head units in the customer's vehicle.

13. A system builder as defined in claim 5 wherein the vehicle information of the customer's vehicle is used for determining opening sizes for speakers in the customer's vehicle.

14. A system builder as defined in claim 5 wherein the statements for each of the main system are expressed in such a way to assess the requirements by the customer for establishing the automobile entertainment system.

15. A system builder as defined in claim 5 wherein the recommended components listed in the component selection page are displayed in an order determined by the supplier based on one or more factors including prices, popularity, profitability, and amounts of stocks of the components.

16. A system builder as defined in claim 5 wherein the supplier terminal and the customer terminal are either of workstations and personal computers.

17. A method of building an automobile entertainment system by a customer using components provided by a supplier, comprising the following steps of:
accessing a supplier terminal by a customer terminal through a communication network for activating a user graphic interface on the customer terminal;
listing a plurality of main systems each being expressed by an image of the main system and statements describing the main system;
selecting one of the main systems that matches customer's requirements;
displaying a plurality of sub-systems within the main system each being expressed by an image of the sub-system and associated statements where the image shows relationships among components in the sub-system;
selecting one of the sub-systems that matches the customer's requirements;
supplying information regarding customer's vehicle for determining fitment of the components with respect to physical conditions of the customer's vehicle;
displaying a list of recommended components appropriate for configuring the selected sub-system in which each component being accompanied by price information and model name; and
selecting components configuring the sub-system that match the customer's requirement.

18. A method of building an automobile entertainment system as defined in claim 17, further comprising a step of confirming final selection of the sub-system and the selected components that compose the selected sub-system.
